(19) United States
(12) Patent Application Publication
(10) Pub. No.: US 2003/0076368 A1
(43) Pub. Date: Apr. 24, 2003

(54) Method for displaying application programs of a computer system on a screen

(76) Inventor: Tung-Leng Lau, Singapore (SG)

Correspondence Address: NAIPO (NORTH AMERICA INTERNATIONAL PATENT OFFICE), P.O. BOX 506, MERRIFIELD, VA, 22116, US

(21) Appl. No.: 09/682,812

(22) Filed: Oct. 22, 2001

(51) Int. Cl. G09G 5/00

(52) U.S. Cl. 345/864

(57) ABSTRACT

A method of displaying multiple application programs simultaneously is performed in a computer system. The computer system has a main application program and an auxiliary application program. The computer system displays the auxiliary application program on a screen. Upon triggering of a predetermined key, the computer system moves the auxiliary application program down, and displays both the auxiliary application program and the main application program. Upon clicking on an image of the main application program, an image of the auxiliary application program is removed, leaving only the main application program displayed on the screen.

### BACKGROUND OF INVENTION

1. Field of the Invention

The present invention relates to methods of displaying programs on a screen, and more particularly, to a method of displaying applications programs of a computer system on a screen.

2. Description of the Prior Art

Personal data assistants (PDA) are popular tools used for storing addresses, schedules, e-mail, and simple programs, like classic arcade games and new time-killing favorites. With the advent of wireless technology, PDAs even allow users to download stock information, e-mail, and other data stored in the wireless Internet, from nearly any location, at about any time. Truly, PDAs are the cellular phones of personal computing.

Given the small size and low power consumption of PDAs, it should not be surprising that the computing power offered by these portable devices cannot match that of Deep Blue by IBM. However, PDAs have made significant progress, to the point where they have menu-style operating systems, and a plethora of applications, a good part of which are not related to data assistance.

Still, the menu-style operating system is rather limited, and confuses many users who are adjusted to sophisticated GUI”s. Typically, only one application may be displayed on the PDA at once. But, in a case where a user must access data from multiple applications, the user must constantly switch back and forth between said applications, with a large probability of incorrectly copying data. So, should Windows ME be run on PDAs to offer more flexibility to the user? May it never be! It is debatable whether Windows ME should be run on a personal computer, let alone on a PDA. Therefore, a compromise that combines both functionality and simplicity must be found, so that users may access multiple programs simultaneously, and save time.

### SUMMARY OF INVENTION

Therefore, it is an objective of the claimed invention to provide a method of simultaneously displaying multiple application programs on a screen of a computer system, so as to save time and increase functionality of the system.

Briefly, the claimed invention provides a method of displaying application programs of a computer system on a screen. The computer system comprises a main application program and an auxiliary application program. When the auxiliary application program is opened and the main application program is closed, triggering a predetermined key moves the auxiliary application program, and opens the main application program. Thus, an image of the auxiliary application program and an image of the main application program are both displayed on the screen.

It is an advantage of the present invention that multiple programs may be displayed on a screen of a computer system at one time, saving time for a user.

These and other objectives and advantages of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a perspective view of a PDA using the method of the present invention.

FIG. 2 is a perspective view of the PDA in FIG. 1 displaying an auxiliary application program.

FIG. 3 is a perspective view of the PDA in FIG. 1 displaying the auxiliary application program and a main application program.

FIG. 4 is a perspective view of the PDA in FIG. 1 displaying the main application program.

### DETAILED DESCRIPTION

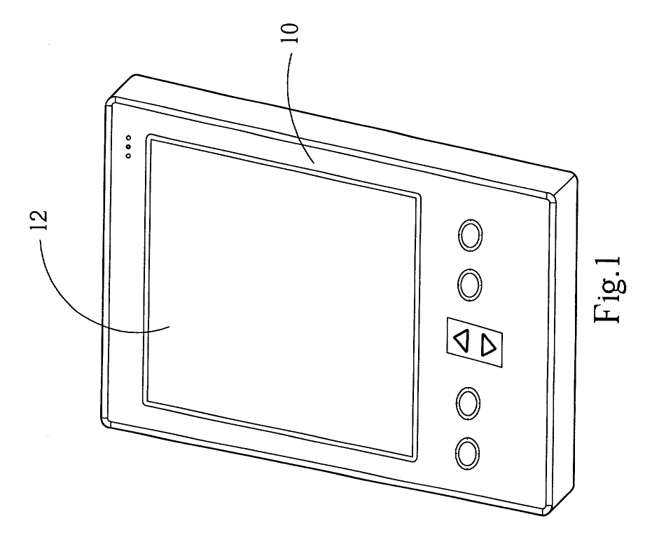

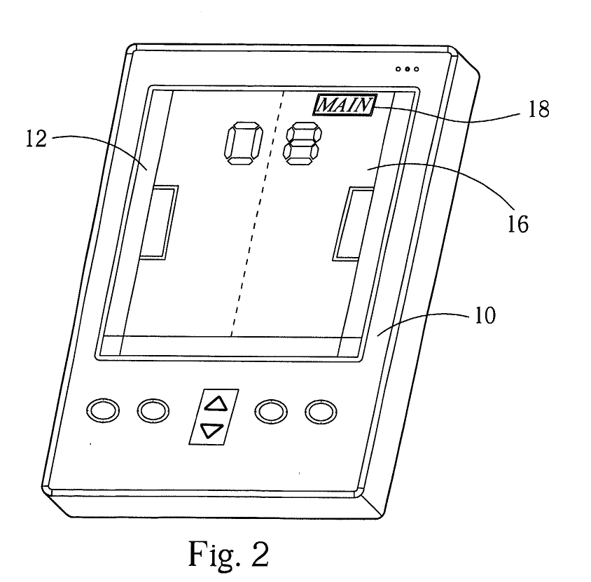

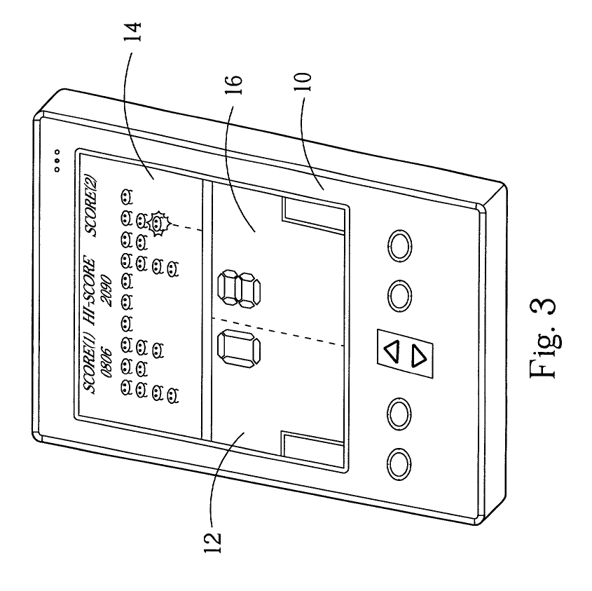

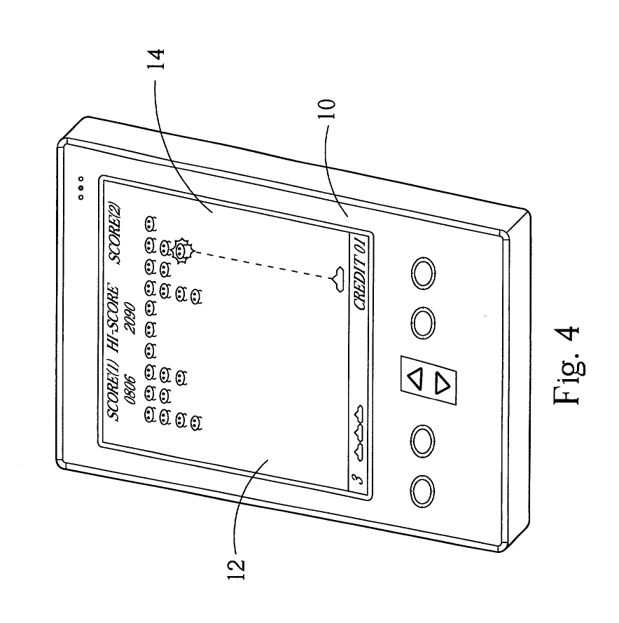

Please refer to FIG. 1, which is a perspective view of a PDA 10 using the method of the present invention. The PDA 10 has a screen 12, by which are displayed programs. In the method of the present invention, two application programs are running, a first of which is designated as a main application program 14 (shown in FIGS. 3-4), and a second of which is designated as an auxiliary application program 16 (shown in FIGS. 2-3). A user, through use of a menu or other means, may perform such designation. Please note that though the present invention method is described for use with two application programs, extension to a method for use with more than two application programs is anticipated.

Please refer to FIG. 2, which shows a state where the screen 12 of the PDA 10 is displaying the auxiliary application program 16. If the user wishes to switch to use the main application program 14, then a predetermined key 18 on the screen 12 may be engaged. Please note that the predetermined key 18 need not necessarily be a graphic displayed on the screen 12, but may also be realized in a physical button, or other input device.

Please refer to FIG. 3, which shows the PDA 10 displaying both the auxiliary application program 16 and the main application program 14. Upon engagement of the key 18, the auxiliary application program 16 is moved down to occupy only half of the screen 12. The main application program 14 is displayed on the upper half of the screen 12. Of course, it should be obvious that any arrangement including upper-, lower-, right- and left-half orientations on the screen 12 of the main application program 14 and the auxiliary application program 16 is anticipated by the present invention method. Further, screen area used by the main application program 14 and the auxiliary application program 16 need not be equal.

Please refer to FIG. 4, which shows the PDA 10 displaying only the main application program 14. As shown, after clicking on a portion of the display of the main application program 14, the display of the auxiliary application program 16 is hidden, and only the main application program is displayed on the screen 12. To be sure, this function can be realized through engaging a graphical bar on the display of the main application program 14, pressing a button on the PDA 10, or any other such method of sending input to the PDA 10.

The present invention method is described for use in the PDA 10. However, it should be noted that this method could be realized in any technology including a screen for displaying programs. Particularly, application to cellular phones is anticipated by the present invention method.

In contrast to the prior art display method, the method of the present invention allows a user to display two application programs at once on a screen of a computer system. This allows the user to have information from one application readily available for reference or use in another application. Thus, the user can save much time.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for displaying application programs of a computer system on a screen, the computer system comprising a main application program and at least one auxiliary application program, the method comprising:
when the auxiliary application program is opened and the main application program is closed, trigger a predetermined key to move the auxiliary application program and open the main application program so as to display an image of the auxiliary application program and an image of the main application program on the screen.

2. The method of claim 1 further comprising:
after the image of the main application program is displayed on the screen, click on the image of the main application program to remove the image of the auxiliary application program.

3. The method of claim 1 wherein after triggering the predetermined key, the image of the auxiliary application program will move to a lower portion of the screen, and the image of the main application will be displayed at an upper portion of the screen.

4. The method of claim 1 wherein the predetermined key is displayed on the screen.

5. The method of claim 1 wherein the computer system is a personal data assistant (PDA).

6. The method of claim 1 wherein the computer system is a cellular phone.
